(19) United States
(12) Patent Application Publication
(10) Pub. No.: US 2010/0198682 A1
(43) Pub. Date: Aug. 5, 2010

(54) SENSITIVE SKIN PRODUCT MARKETING ARTICLES

(76) Inventors: Miranda Aref Farage, Mason, OH (US); Dean Larry DuVal, Lebanon, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/365,291

(22) Filed: Feb. 4, 2009

(51) Int. Cl. G06Q 30/00

(52) U.S. Cl. 705/14.49

(57) ABSTRACT

Sensitive skin product marketing articles that are designed to communicate to consumers of sensitive skin products the relevance and/or characteristics of the sensitive skin product are provided.

### FIELD OF THE INVENTION

The present invention relates to sensitive skin product marketing articles that are designed to communicate to consumers of sensitive skin products the relevance and/or characteristics of the sensitive skin product.

### BACKGROUND OF THE INVENTION

Consumer behavior is a complex subject. Although it has been studied extensively within the realm of marketing science, much remains to be understood. The complexity and variety of things such as human perceptions, experiences, pre-existing knowledge, opinions and attitudes, cultural influences, social influences, demographics, emotions, motivations and reasoning processes in commercial settings often defy attempts to develop general rules or models that are consistently predictive of the perception, behavior or response of a consumer market segment in any particular set of circumstances.

For this reason, when producers of consumer products contemplate a new product launch, they often engage in extensive specific consumer research in an attempt to identify elements of an advertising theme, message, and specific embodiment and execution thereof that will be most effective in stimulating consumer interest, and most importantly, initial purchase intent by effectively communicating to particular consumers the benefits of a particular product and how a particular product meets an unmet need in consumer's life. Even when a product has demonstrable relevance, benefits and value for a segment of the consumer market, the nature and content of a message that will effectively motivate the consumer are rarely readily apparent or easily discovered. Similarly, conceptualization and design of materials that will effectively convey that message are not often easily accomplished. To make the task more difficult, the message may be effective but the materials may be ineffective, or vice versa, and the component in which the weakness exists may not be apparent.

Sometimes complicating the situation further is the condition, presented in many instances, in which relevant consumers may have, or only be willing to devote, limited attention and time to receiving and processing material presented. Without intending to be bound by theory, it is believed generally that consumers will devote comparatively less attention and time to receiving and processing advertising material relating to relatively low-risk (e.g., routine and relatively inexpensive) purchases, as compared with advertising material relating to relatively high-risk (e.g., relatively expensive) purchases. Thus, the additional challenge of designing an advertising message, theme, embodiment and execution that will be both rapidly perceived and processed, as well as effective at reaching the target market segment and stimulating interest, may be presented when a relatively inexpensive product involving a routine purchase is involved.

Persons experienced in the field recognize that even with substantial investments in expertise, effort and pre-testing, many marketing/advertising executions prove ineffective, for reasons often only appreciated in hindsight.

In the instant situation, it has been recognized that communication of the benefits of sensitive skin products is a unique challenge due to differences in how different ethnographic groups recognize and communicate the symptoms of sensitive skin. Some ethnographic groups are more prone to claim visual effects as being associated with product interactions while other ethnographic groups are more prone to claim sensory effects as being associated with product interactions. Still other ethnographic groups are more prone to describe sensitive skin as being associated with physical effects.

Moreover, it has also been recognized that communication of the benefits of sensitive skin products is further challenged due to connections within familiar groups to sensitive skin issues. Some familiar groups are simply not aware of the commonality of issues related to sensitive skin and associated consumer product usage, especially within families, and are therefore uncomfortable in discussing sensitive skin issues. This may be due to perceived stigma or embarrassment associated with having sensitive skin.

Therefore, a need exists for a sensitive skin product marketing article that rapidly and effectively communicates to sensitive skin product consumers the relevance and/or characteristics of the sensitive skin product (or sensitive skin products having similar characteristics), so as to better stimulate interest and initial purchase intent.

### SUMMARY OF THE INVENTION

The present invention fulfills the need described above by providing sensitive skin product marketing articles that communicate to sensitive skin product consumers the relevance and/or characteristics of the sensitive skin product. Non-limiting examples of sensitive skin product marketing articles include product packages, shelf displays, tangible medium, and videographic medium.

In one example of the present invention, a sensitive skin product marketing article, such as a sensitive skin product package for housing a sensitive skin product, comprises indicia comprising textual, graphical and/or pictorial representations of symptoms of sensitive skin, is provided. In one example, the indicia comprises textual representations of symptoms of sensitive skin, wherein the indicia is organized into one and/or two and/or three or more groups based upon visual, sensory and physical characteristics of the symptoms of sensitive skin. In another example, the indicia comprises a microphotograph of human skin that depicts a symptom of sensitive skin.

In another example of the present invention, an array of sensitive skin product marketing articles (i.e., sensitive skin product packages) comprising three or more different sensitive skin product packages housing sensitive skin products, wherein at least one and/or at least two and/or at least three of the three or more different sensitive skin product packages comprises indicia comprising textual, graphical and/or pictorial representations of symptoms of sensitive skin, is provided. In one example, all of the sensitive skin products within the array are made by the same company, i.e., a single source. In another example, all of the sensitive skin product packages within the array comprise a common indicia. In yet another example, all of the sensitive skin product packages within the array comprise an image of an individual from a common ethnographic group.

Accordingly, the present invention provides a sensitive skin product marketing article, such as a sensitive skin product package, that comprises indicia that represent symptoms of sensitive skin and an array of such sensitive skin product packages.

### BRIEF DESCRIPTION OF THE DRAWINGS

FIG. 1 is a perspective view of an example of a sensitive skin product marketing article according to the present invention;

FIG. 2 is a perspective view of another example of a sensitive skin product marketing article according to the present invention;

FIG. 3 is a perspective view of another example of a sensitive skin product marketing article according to the present invention; and

FIG. 4 is a perspective view of an example of a sensitive skin product package array according to the present invention.

### DETAILED DESCRIPTION OF THE INVENTION

### Definitions

“Sensitive skin product marketing article” as used herein means a package that houses a sensitive skin product and/or a billboard and/or newspaper and/or magazine and/or coupon and/or internet site and/or in-store displays (for example, shelf displays or “shelf talkers,” brochures, booklets, leaflets, fliers, postcards, specially adapted boxes, bins, cartons, racks, shelving, showcases, tables, kiosks, counters, stands and the like, signs, posters and banners, including electronic versions of the same, placed or displayed in proximity to a sensitive skin product in the store) and/or any other tangible medium (for example, electronic storage medium (such as a flash memory device, hard drive, etc.) containing stored visual content, together with equipment that reads from the electronic storage medium and makes the visual content available for viewing by humans, computer and related equipment used to store visual content and deliver it, for example, by electronic mail. that markets a sensitive skin product to consumers).

“Sensitive skin product package” as used herein means a package that houses a sensitive skin product.

“Sensitive skin products” includes any and all consumer products developed or formulated to be “gentle” or “mild” to the skin. These consumer products may come in direct contact with the skin, be worn adjacent to or in direct contact with the skin, or applied to garments that may then come into contact with the skin. Non-limiting examples of consumer products that may come into direct contact with the skin include; cosmetics, skin lotions, shampoos, conditioners, hair colorants, moisturizers, body washes, soaps, mouth washes, toothpaste, shaving cream, razors, deodorants, antiperspirants, etc. Non-limiting examples of sanitary consumer products that may be worn adjacent to or in direct contact with the skin include; diapers, feminine hygiene products, adult incontinence products, toilet paper, facial tissue, paper towels, paper napkins, etc. The sanitary consumer products may comprise a lotion. Non-limiting examples of consumer products that may be applied to garments that may then come into contact with the skin include; clothes washing detergents, fabric softeners, bleaches, insect repellent, ironing aides, etc.

“Ethnographic language” as used herein means words consistent with those used by an ethnographic subgroup of the population to describe a given condition. In the immediate situation, this would include words to describe sensitive skin. It was only very recently recognized through clinical research that different ethnographic groups use different ethnographic language to describe sensitive skin or sensitive skin symptoms. For instance, it has been found that Caucasian-Americans more often claim consumer products produce visual effects (17.71%) versus sensory effects (15.16%). Therefore, the most common ethnographic language used by this subgroup would include, but would not be limited to, the terms “redness” and “swelling”. African-Americans more often claim consumer products produce sensory effects (26.83%) versus visual effects (18.70%). Therefore, the most common ethnographic language used by this subgroup would include, but would not be limited to, the terms “burning” and “stinging”. Hispanic-Americans more often claim consumer products produce physical effects (10.5%) versus visual effects (5.26%). Therefore, the most common ethnographic language used by this subgroup would include, but would not be limited to, the terms “friction” and “rubbing”. Asian-Americans more often claimed products produced combined visual and sensory effects (47.4%) than other groups, for instance; African-Americans (45.5%), Caucasian-Americans (33%), Hispanic-Americans (21%), or the total population (17.08%). Therefore, the most common ethnographic language used by this subgroup would include, but would not be limited to, the terms “redness”, “swelling”, “burning”, and “stinging”.

“Age Differences” as used herein means that for some groups of the population and some locations on the body, the perception of sensitive skin will be dependent on age. For instance, for the entire group, the perception of sensitive skin in general, and of the face and body were not dependent on age. However, the perception of sensitive skin of the genital area was recently found to be dependent on age, with older individuals more likely to claim sensitive genital skin. When men and women were split out separately and compared, it was found that the perception of sensitive genital skin was dependent on age for women, but not for men.

“Gender Differences” means that for one of the genders, there is a difference in the perception of sensitive skin. In general, there is no difference in the perception of sensitive skin of the face and body. However, as indicated supra the perception of sensitive genital skin was found to be significantly higher in women compared to men.

“Proximate to” (and forms thereof), when used to characterize the location of a second object with respect to the location of a first object, means any location of the second object whereby a human viewer may view both objects by moving the eyes or head, or by turning about, bending, stretching or kneeling, from a single vantage point, but without moving the body substantially away from the vantage point. A second object will be “proximate to” a first object if a viewer can see both objects from any single vantage point.

### Sensitive Skin Product Marketing Article

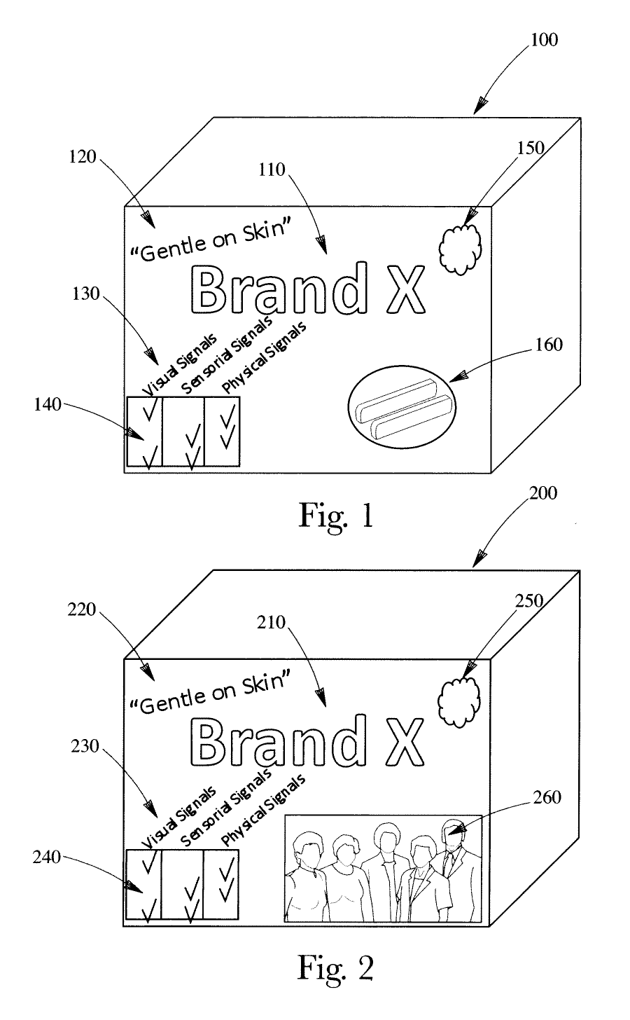

As shown in FIG. 1, a sensitive skin product marketing article, in this case a sensitive skin product package 10, comprises a brand name or single source identifier 12, a textual slogan 14 that communicates to consumers that the sensitive skin product housed within the sensitive skin product package was designed for sensitive skin, indicia comprising textural representations of symptoms for sensitive skin 16 organized in a group, indicia comprising graphical representations of symptoms for sensitive skin 18 associated with the indicia comprising the textual representations 16. As shown FIG. 1, the sensitive skin product marketing article may further comprise, and endorsement icon 150, and a micrograph of human skin 160.

FIG. 2 is a perspective view of an exemplary embodiment of a sensitive skin product package 200 and shows a brand name or single source identifier 210, a slogan communicating to consumers that the product was designed for sensitive skin 220, a group or cluster of indicia comprising textual descriptions of symptoms for sensitive skin 230, a group or cluster of indicia graphically communicating symptoms for sensitive skin 240, and endorsement icon 250, and a photograph of a group of individuals with ethnographic diversity 260.

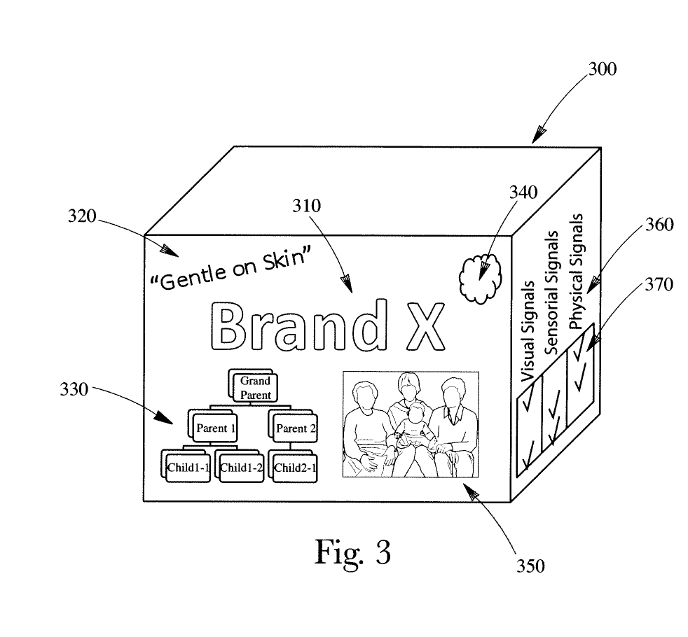

FIG. 3 is a perspective view of an exemplary embodiment of a sensitive skin product package 300 and shows a brand name or single source identifier 310, a slogan communicating to consumers that the product was designed for sensitive skin 320, a graphical representation of a group of genetically related individuals 330, a group or cluster of indicia comprising textual descriptions of symptoms for sensitive skin 360, a group or cluster of indicia graphically communicating symptoms for sensitive skin 370, an endorsement icon 340, and a photograph of a group of apparently genetically related individuals 360.

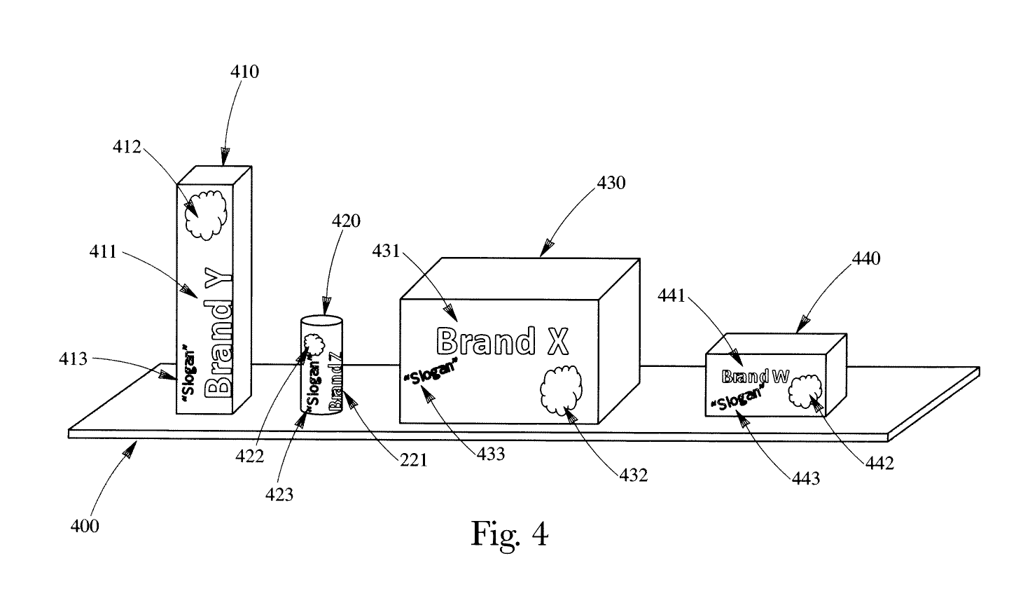

FIG. 4 is a perspective view of an exemplary embodiment of an array of sensitive skin product packages 410, 420, 430, and 440 on a display shelf 400. Each product package had a brand name or single source identifier 411, 421, 431, and 441 which may or may not be the same as the other brand names. Each product also has an indicia or icon 412, 422, 432, and 442 indicating that each product has an endorsement by the same scientific or technical organization related to skin health or skin mildness. Optionally, each package may contain a slogan communicating to consumers that the product was designed for sensitive skin 413, 423, 433, and 443 indicating that each product was intended for use by individuals with sensitive skin. Interest-Generating Content

It is believed that content including one or more combinations of certain visual and/or ethnographic elements, examples of which elements are described further herein, is more effective at stimulating interest and initial purchase intent than other content not having such a combination of visual and/or ethnographic elements. Generally, the relevant consumer market segment is deemed to be, primarily, consumers who are self-diagnosed as having sensitive skin.

As exemplified by the Figures, the visual content may include indicia, symptom icons, charts, graphs, endorsements, endorsement seals, microphotographs, human photographs or videographic images of one or more actual human subjects, objects and settings. Without intending to be bound by theory, it is believed that use of such indicia, icons, charts, graphs, endorsements, endorsement seals, microphotographs, human photographs or videographic images of one or more actual human subjects in these circumstances is more effective for rapid conveyance and processing of information than other forms of communication such as oral or written verbal communication. Without intending to be bound by theory, it is believed that the realistic appearance of data, endorsements, microphotographs, photographs or videographic images of appropriate subject matter generally is perceived by the consumer as more credible and concrete as a depiction of a real-life situation likely to be experienced by the consumer. Without intending to be bound by theory, it believed further that the information contained and conveyed is much more abundant and detailed, but at the same time much more quickly processed by the consumer. It is believed that this is because fewer intervening mental steps are required to process and understand the information, e.g., reading, interpreting, categorizing and mentally placing in context information that is presented in more abstract form, are required.

In one example of the present invention, a sensitive skin product marketing article, such as a sensitive skin product package for housing a sensitive skin product, comprises an image of one or more individuals representing one or more ethnographic groups and ethnographic textual representations of symptoms of sensitive skin used by the ethnographic groups. In another example of the present invention, the image comprises individuals that represent two or more ethnographic groups. In yet another example of the present invention, the image comprises individuals that represent adults, for example adults with an apparent age of greater than 50 years of age. In even another example of the present invention, the image comprises individuals that represent adult women. In still yet another example of the present invention, the ethnographic language may be present in chart form containing both textual and visual cues. In addition to the image, the sensitive skin product marketing article may further comprise a microphotograph of human skin from an individual of the ethnographic group, wherein the microphotograph of human skin depicts a symptom of sensitive skin for that ethnographic group.

In another example, a store display is presented for viewing by consumers with sensitive skin, wherein the display contains visual content comprising images of individuals representing one or more ethnographic groups and ethnographic language describing symptoms of sensitive skin consistent with the ethnographic group(s) represented in the visual content on the package.

In another example, a tangible medium is presented for viewing by consumers with sensitive skin, wherein the tangible medium contains visual content comprising images of individuals representing one or more ethnographic groups and ethnographic language describing symptoms of sensitive skin consistent with the ethnographic group(s) represented in the visual content on the package. Non-limiting examples of such tangible medium includes print advertisements, flyers in magazines and/or newspapers circulated to the public, especially magazines and/or newspapers that have household interest, family interest, cosmetic interest and/or parent interest-oriented theme and content. Current examples include magazines such as AMERICAN BABY, PARENTING, JUNIOR, PARENTS, COOKIE, KIWI, REDBOOK, GOOD HOUSEKEEPING, FAMILY FUN, FAMILY TIMES, TANGO, BABY COUTURE, CHILDREN'S PLAYMATE, PARENTLIFE, PRIMA BABY, CONCEIVE, TODAY'S PARENT, LADIES HOME JOURNAL, BETTER HOMES AND GARDENS, FAMILY CIRCLE, WORKING MOTHER, MORE, MOTHERVERSE, VOGUE, GLAMOUR, ELLE and COSMETICS AND TOILETRIES.

Other examples of tangible medium that may be used in accordance with the present invention include signs or displays that are in public view, such as inside a retail store in which the sensitive skin product is available for purchase, or outside and proximate to a retail store in which the sensitive skin product is available for purchase.

Still other examples of tangible medium that may be used in accordance with the present invention include signs, posters and/or billboards affixed or placed inside or outside a public bus or train, or along a public sidewalk or public roadway.

In another example, a sensitive skin marketing article comprising visual content related to the sensitive skin product may be transmitted via electronic mail (email), text messaging, iPod® transmission, Facebook and/or MySpace electronic media to parents and/or grandparents of babies, children and teens or other persons associated with the sensitive skin product market segment. In another example, the visual content may be displayed on web sites designed for, or frequented by, parents and/or grandparents of babies, children and teens or other persons associated with the sensitive skin product market segment. Current examples of such web sites include those having the domain names justmommies.com. beinggirl.com and babycenter.com. Similarly, one or more of the magazines identified above publish online/web versions, on which the visual content may also be displayed.

In another example, a videographic medium is presented for viewing by consumers with sensitive skin, wherein the videographic medium contains visual content comprising images of individuals representing one or more ethnographic groups and ethnographic language describing symptoms of sensitive skin consistent with the ethnographic group(s) represented in the visual content on the package.

In another example, a product intended for use by consumers with sensitive skin is presented for distribution and/or sale to consumers, wherein the product is contained within a product package containing visual content comprising images of individuals representing two or more generations of a family, and a visual cue suggesting one or more of them have sensitive skin.

Optionally, one of the individuals representing one of the generations of the family is an infant between 0 and 3 years of age.

Optionally, one of the individuals representing one of the generations of the family is a child between 3 and 12 years of age.

Optionally, the individuals representing one of the generations of the family is an older adult with an apparent age greater than 50 years.

Optionally, the visual content on the disposable consumer product package contains textual or graphical information indicating a genetic connection between the individuals on the package.

In another example, a store display is presented for viewing by consumers with sensitive skin wherein the display contains visual content comprising images of individuals representing two or more generations of a family, and a visual cue suggesting one or more of them have sensitive skin.

In another example, a store display is presented for viewing by consumers with sensitive skin, wherein the display contains visual content comprising images of individuals representing one or more ethnographic groups and ethnographic language describing symptoms of sensitive skin consistent with the ethnographic group(s) represented in the visual content on the package.

In another example, a tangible medium is presented for viewing by consumers with sensitive skin wherein the tangible medium contains visual content comprising images of individuals representing two or more generations of a family, and a visual cue suggesting one or more of them have sensitive skin.

In another example, a videographic medium is presented for viewing by consumers with sensitive skin wherein the videographic medium contains visual content comprising images of individuals representing two or more generations of a family, and a visual cue suggesting one or more of them have sensitive skin.

### Array of Sensitive Skin Product Packages

An array of sensitive skin product packages comprising three or more different sensitive skin product packages housing sensitive skin products, wherein at least one and/or at least two and/or at least three of the three or more different sensitive skin product packages comprises indicia comprising textual, graphical and/or pictorial representations of symptoms of sensitive skin, is provided. In one example, all of the sensitive skin products within the array are made by the same company, i.e., a single source. In another example, all of the sensitive skin product packages within the array comprise a common indicia. In yet another example, all of the sensitive skin product packages within the array comprise an image of an individual from a common ethnographic group.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sensitive skin product marketing article comprising indicia comprising textual, graphical and/or pictorial representations of symptoms of sensitive skin, wherein the indicia are organized into one or more groups based on visual, sensory and/or physical characteristics of the symptoms.

2. The sensitive skin product marketing article according to claim 1 wherein two or more of the groups of indicia are represented on the sensitive skin product marketing article.

3. The sensitive skin product marketing article according to claim 1 wherein one or more of the groups of indicia are graphical representations of the symptoms.

4. The sensitive skin product marketing article according to claim 1 wherein one or more of the groups of indicia comprise microphotographs.

5. The sensitive skin product marketing article according to claim 1 wherein the sensitive skin product marketing article further comprises visual content comprising images of individuals representing one or more ethnographic groups and ethnographic language describing symptoms of sensitive skin predominately used by the ethnographic group(s) represented in the visual content on the sensitive skin product marketing article.

6. The sensitive skin product marketing article according to claim 5 wherein the images of individuals represent two or more ethnographic groups.

7. The sensitive skin product marketing article according to claim 5 wherein the images of individuals representing the one or more ethnographic groups comprise elderly adults.

8. The sensitive skin product marketing article according to claim 5 wherein the images of individuals representing the one or more ethnographic groups comprise women.

9. The sensitive skin product marketing article according to claim 5 wherein the ethnographic language describing the symptoms of sensitive skin are in a chart form containing both textual and visual cues.

10. The sensitive skin product marketing article according to claim 5 wherein the sensitive skin product marketing article may further comprise visual content comprising microphotographs of human skin visually depicting the symptoms of sensitive skin consistent with the ethnographic language used by the ethnographic groups represented in the visual content on the sensitive skin product marketing article.

11. The sensitive skin product marketing article according to claim 1 wherein the sensitive skin product marketing article comprises a sensitive skin product package for housing a sensitive skin product.

12. The sensitive skin product marketing article according to claim 11 wherein the sensitive skin product comprises a sanitary consumer product.

13. The sensitive skin product marketing article according to claim 12 wherein the sanitary consumer product comprises a lotion.

14. An array of sensitive skin product marketing articles comprising three or more different sensitive skin product packages housing sensitive skin products, wherein at least one of the three or more different sensitive skin product packages comprises indicia comprising textual, graphical and/or pictorial representations of symptoms of sensitive skin.

15. The array of sensitive skin product marketing articles according to claim 14 wherein all of the sensitive skin products are made by the same company.

16. The array of sensitive skin product marketing articles according to claim 14 wherein all of the sensitive skin product packages within the array comprise a common indicia.

17. The array of sensitive skin product marketing articles according to claim 14 wherein all of the sensitive skin product packages within the array comprise an image of an individual from a common ethnographic group.

18. The array of sensitive skin product marketing articles according to claim 14 wherein all of the sensitive skin product packages with the array comprise visual content comprising images of individuals representing two or more generations of a family, and a visual cue indicating that at least one of the individuals has sensitive skin.

19. The array of sensitive skin product marketing articles according to claim 18 wherein at least one of the individuals representing one of the generations of the family is an infant.

20. The array of sensitive skin product marketing articles according to claim 18 wherein at least one of the individuals representing one of the generations of the family is a child.

21. The array of sensitive skin product marketing articles according to claim 18 wherein at least one of the individuals representing one of the generations of the family is an adult.

22. The array of sensitive skin product marketing articles according to claim 14 wherein all of the sensitive skin product packages comprises a common endorsement from a professional organization.
